(19) United States
(12) Patent Application Publication
(10) Pub. No.: US 2019/0154088 A1
(43) Pub. Date: May 23, 2019

(54) COUPLING DISC

(71) Applicant: Cummins Generator Technologies Limited, Peterborough (GB)

(72) Inventors: Shaun Green, Peterborough (GB); Abhinav Tobin, Peterborough (GB)

(73) Assignee: Cummins Generator Technologies Limited, Peterborough (GB)

(21) Appl. No.: 16/300,003

(22) PCT Filed: May 10, 2017
(86) PCT No.: PCT/GB2017/051290

§ 371 Date: Nov. 8, 2018

(30) Foreign Application Priority Data
May 11, 2016 (GB) 1608277.8

(51) Int. Cl. F16D 3/77; H02K 7/00; F16D 3/72

(52) U.S. Cl. CPC F16D 3/77; F16D 3/72; H02K 7/003

(57) ABSTRACT

A coupling disc (40) is disclosed for coupling a rotating electrical machine to a prime mover. The disc comprises an inner region (42) for connection to a rotating component of the electrical machine, and an outer region (46) for connection to a rotating component of the prime mover, the inner region and the outer region lying in a different plane. The disc further comprises an intermediate region (42) between the inner region and the outer region, the intermediate region comprising a plurality of slots (52). This may allow two or more discs to be stacked together in such a way that interference between the surface profiles of adjacent discs is reduced or avoided. Furthermore, the slots in the intermediate region may reduce the strain placed on the material when forming the disc, thereby facilitating manufacture.

The present invention relates to a coupling disc for coupling a rotating electrical machine to a prime mover. The present invention has particular, but not exclusive, application in generating sets comprising a generator coupled to an internal combustion engine.

Generating sets typically comprise an internal combustion engine, such as a diesel engine, which drives an electrical generator (alternator). The generator may be coupled to the engine using a coupling disc which connects the shaft of the generator to the engine flywheel.

Known coupling discs have an outer pitch circle of holes which are used to connect the disc to the engine flywheel, and an inner pitch circle of holes which are used to connect the disc to the shaft. To make the connection to the shaft, a hub is shrunk on to the shaft. The hub is designed to locate the disc axially and to carry bolts that hold the disc in place through the inner pitch circle of holes.

Coupling discs are typically manufactured from relatively thin sheets of metal. In some cases it may be necessary to stack a number of discs together in order to achieve the required torque transmission characteristics.

In existing coupling disc designs, the need to shrink a hub onto the shaft adds to the cost and complexity of manufacture. Attempts have therefore been made to bolt a coupling disc directly onto the generator shaft. However this may result in the coupling fixing bolts interfering with other components such as the engine flywheel or flywheel fixing bolts. In order to solve this problem, it has been proposed to reduce the length of the generator shaft, and to bend the coupling disc into a dish shape. This extends the axial reach of the coupling disc, so that the flywheel interface position does not change.

A problem which has been found with previously considered dish-shaped disc designs is that, if two or more similar or identical discs are stacked together, the surface profiles interfere with one another and the bent areas are not flush. This restricts the use of dish-shaped disc designs to a single disc, resulting in a limitation of torque transmission capabilities.

Another difficulty encountered when trying to manufacture stackable dished discs by plastically straining the material to the desired geometry is the large material strain values that are required. In some cases these strain values may exceed the strain capabilities of the material being used. This places a limit on the extent to which the coupling disc can be plastically deformed into a dish shape, which may in turn limit the applications in which dish-shaped disc designs can be used.

According to a first aspect of the present invention there is provided a disc for coupling a rotating electrical machine to a prime mover, the disc comprising an inner region for connection to a rotating component of the electrical machine and an outer region for connection to a rotating component of the prime mover, the inner region and the outer region lying in a different plane, the disc further comprising an intermediate region between the inner region and the outer region, the intermediate region comprising a plurality of slots.

The present invention may provide the advantage that, by providing the intermediate region with a plurality of slots, it may be possible to stack two or more discs together in such a way that interference between the surface profiles of adjacent discs is reduced or avoided. This may allow a plurality of dish-shaped discs to be stacked together, thereby increasing the torque transmission capacity of the coupling. Furthermore, the slots in the intermediate region may reduce the strain placed on the material when forming the disc, thereby facilitating manufacture.

The disc is preferably dish-shaped. Thus the inner region and the outer region may be flat, and the intermediate region may extend between the planes of the inner and outer regions. The inner region may be substantially circular, when viewed axially, while the outer region may be substantially annular. Thus, when viewed axially, the outer region may be a region bounded by two concentric circles.

The inner region and the outer region preferably lie in planes which are parallel to each other. Preferably at least one of the inner region and the outer region lies in a plane which is perpendicular to an axis of rotation of the electrical machine. The intermediate region is preferably at an angle to the plane of the inner region and/or outer region. For example, the intermediate region may lie at an angle of at least 20°, 25° or 30° and/or less than 60°, 55° or 50° to the inner region and/or outer region, although other values are possible. The intermediate region may be substantially frusto-conical in shape.

Preferably the slots are spaced circumferentially about the intermediate region. The areas between the slots may act as a plurality of “ribs” for connecting the inner region and the outer region, thus helping to ensure structural integrity. Such an arrangement may also help with forming the disc into a dish shape by reducing the strain values placed on the material.

Preferably the slots account for at least 50% of the circumferential area around the intermediate region. For example, the width of the slots in a circumferential direction may be equal to or greater than the distance between adjacent slots. This may provide the advantage that, when two or more discs are stacked together, an area between two adjacent slots in one disc can align with a slot in another disc, which may help to avoid interference between the discs.

In one embodiment, 12 slots are provided in the intermediate region, with an angle of approximately 30° between adjacent slots, although more or fewer slots and different angle values may be provided as appropriate.

Preferably the slots are arranged such that, when two discs are stacked together with one disc rotated with respect to the other, the slots in one disc can align with areas between the slots in the other disc. This feature may allow interpenetration of adjacent dish-shaped discs without physical interference of the material.

The inner region may form a centre plate for engagement with a rotor shaft. A hole may be provided at the centre of the inner region, which may be used to locate the disc on the shaft.

The inner region may comprise a plurality of bolt holes for bolting the disc to a rotor shaft. The bolt holes may be arranged in a circle, which may help to provide the maximum torque transmission capability.

The bolt holes may be arranged such that bolts can pass through the bolt holes and into the shaft, without the need for a hub. This may help to reduce machine cost by avoiding the need for a hub and simplifying the shaft machining. However the disc could also be used with a hub, if desired.

The outer region may form a rim for engagement with an engine flywheel. The outer region may comprise a plurality of bolt holes for bolting the disc to a rotating component of the prime mover, such as an engine flywheel. The bolt holes may be arranged in a circle.

Preferably some of the bolt holes lie radially outwards of a slot in the intermediate region, and some of the bolt holes lie radially outwards of an area between two adjacent slots in the intermediate region. This may help to ensure that when two discs are rotated and stacked together at least some of the bolt holes are aligned, so that a bolt can pass through the complete coupling.

The bolt holes may be arranged such that, when two discs are rotated and stacked together in such a way that the slots in the intermediate region in one disc align with areas between the slots in the other disc, at least some of the bolt holes in one disc align with at least some of the bolt holes in the other disc.

In one embodiment, two sets of bolt holes are provided in the outer region, each set of bolt holes offset from the other by an angle equivalent to half of the angle between two adjacent slots in the intermediate region, or an odd multiple thereof. This may help to ensure that, when two or more discs are stacked, at least some of the bolt holes in one disc align with at least some of the bolt holes in the other discs.

The disc may be formed from a sheet of metal or other material which may then be bent into a dish shape. Thus the intermediate region may be formed by bending.

A problem that may be encountered when bending a disc into a dish shape is the large strain values placed on the material. This may be alleviated to a certain extent by providing the slots in the intermediate area, which is the area to be bent. However, in order to further alleviate this problem, the disc may comprise a plurality of slits in the outer region. For example, the slits may be located in the outer region, radially outwards of at least some of the slots in the intermediate region.

The slits may be parallel, and may allow the diameter of the outer region to be reduced as the disc is bent into a dish shape. Preferably the slits are arranged such that they close up when the disc is bent into shape. The slits may then be connected, for example by laser welding, to ensure the integrity of the disc.

According to another aspect of the invention there is provided a coupling comprising a plurality of discs in any of the forms described above. The discs are preferably stacked together, preferably coaxially, with alternate discs rotated with respect to the other discs in the stack. The discs are preferably arranged such that a slot in the intermediate region in one disc is aligned with an area between two slots in the intermediate region in an adjacent disc. At least some bolt holes in one disc are preferably aligned with at least some bolt holes in another disc.

According to another aspect of the invention there is provided a rotor assembly for a rotating electrical machine, the rotor assembly comprising a disc or coupling in any of the forms described above. The rotor assembly may be of a single bearing or a two bearing design.

Corresponding methods may also be provided. Thus, according to another aspect of the invention there is provided a method of manufacturing a disc for coupling a rotating electrical machine to a prime mover, the method comprising forming a plurality of slots circumferentially about an intermediate region of the disc, and forming the disc such that the disc comprises an inner region and an outer region lying in different planes and connected by the intermediate region.

Features of one aspect of the invention may be provided with any other aspect. Apparatus features may be provided with the method aspect and vice versa.

In the present specification, terms such as “axially”, “radially” and “circumferentially” are generally defined with reference to the axis of rotation of the electrical machine.

Preferred features of the present invention will now be described, purely by way of example, with reference to the accompanying drawings, in which:

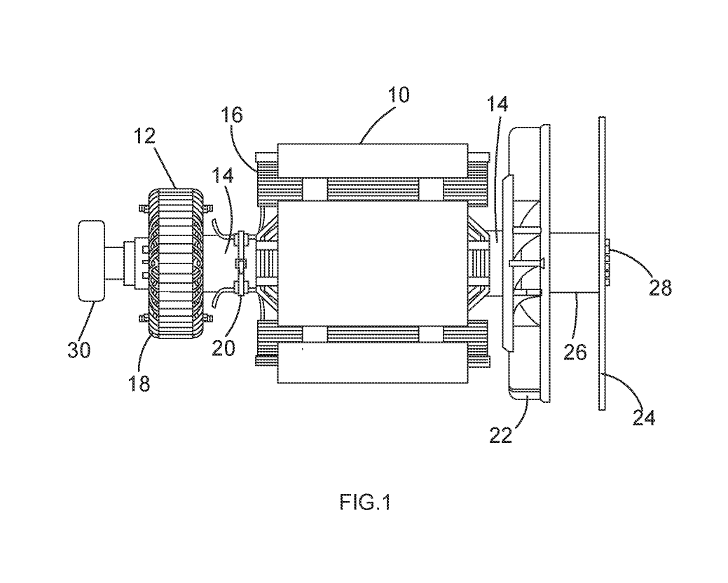

FIG. 1 shows parts of a previously considered rotor assembly for a rotating electrical machine;

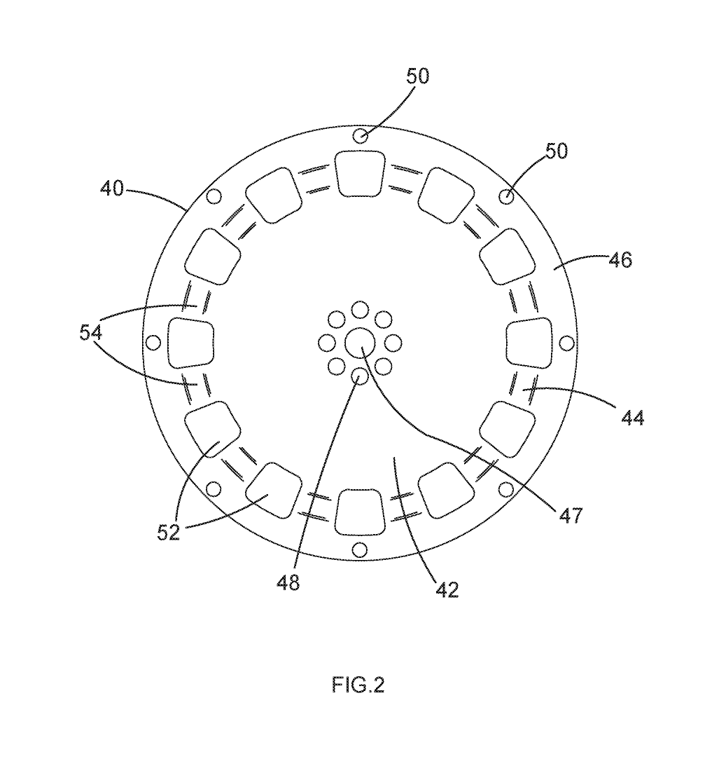

FIG. 2 shows a coupling disc in accordance with an embodiment of the invention;

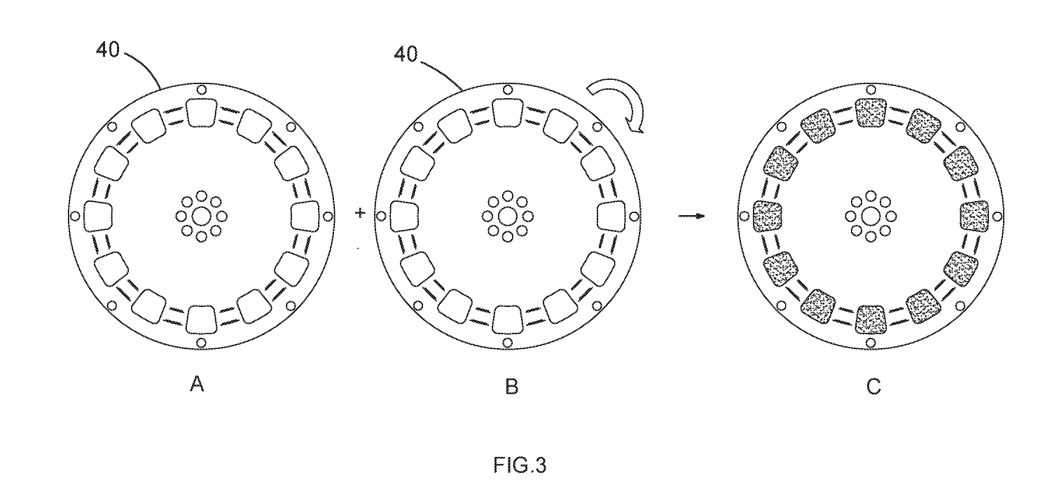

FIG. 3 illustrates the formation of a stacked coupling disc using two of the discs shown in FIG. 2;

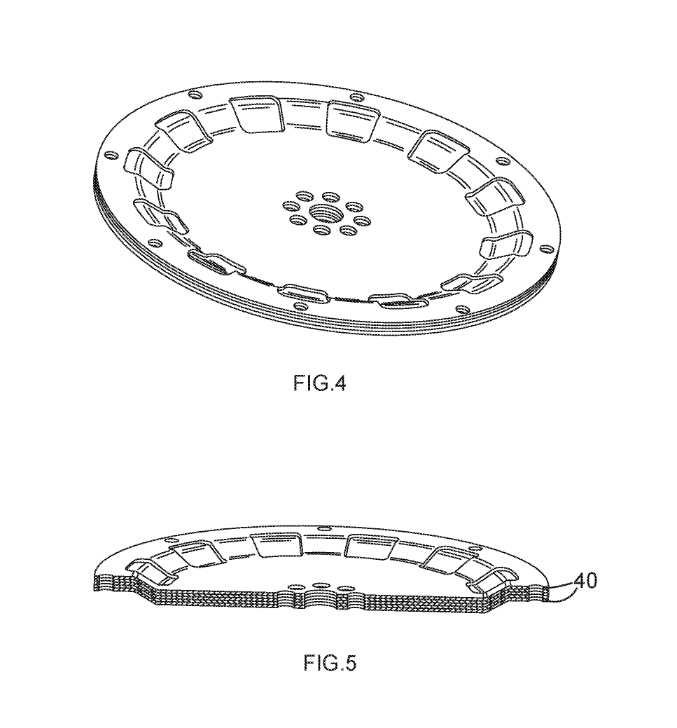

FIG. 4 shows a perspective view of a coupling formed by stacking five dish-shaped discs, each with eight flywheel fixing bolt holes;

FIG. 5 shows a cut-away through the coupling of FIG. 4;

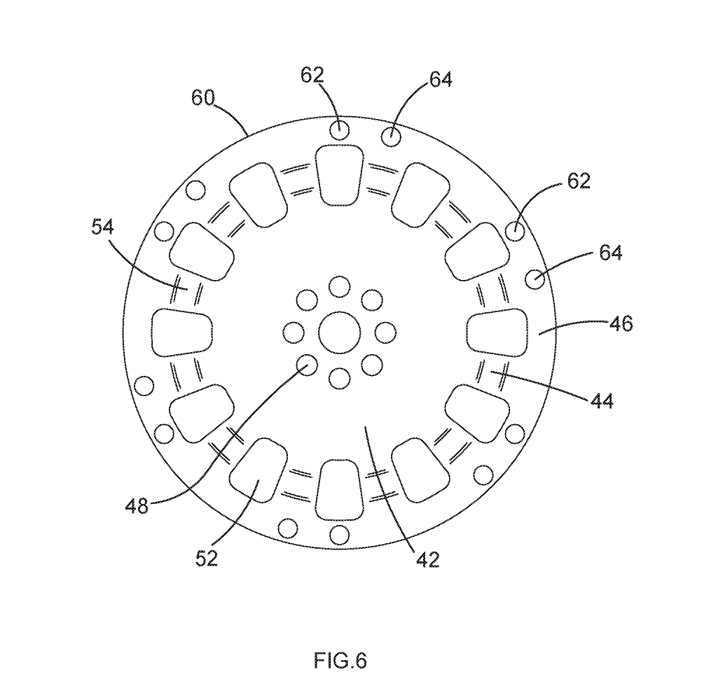

FIG. 6 shows a coupling disc in accordance with another embodiment of the invention;

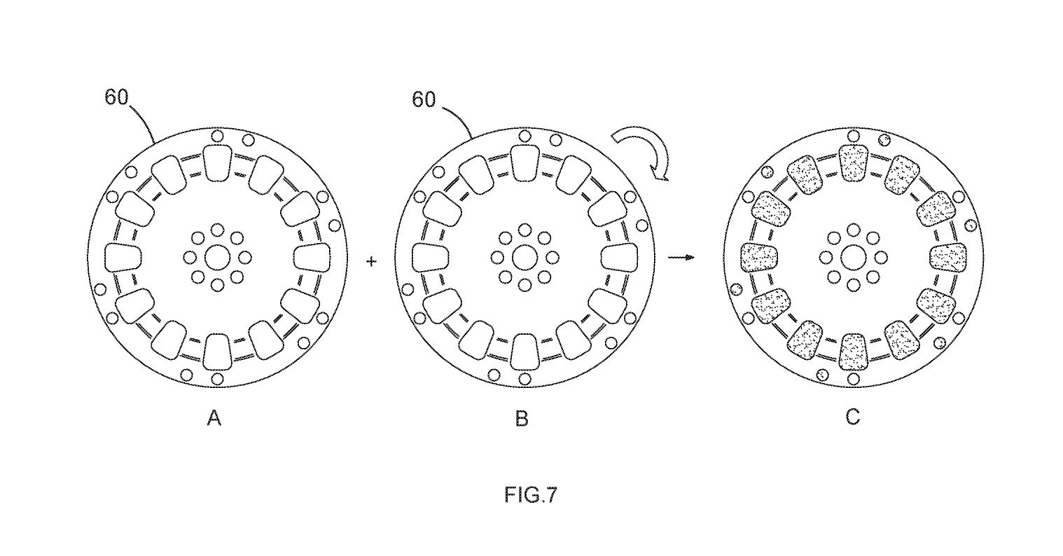

FIG. 7 illustrates the formation of a stacked coupling disc using two of the discs shown in FIG. 6;

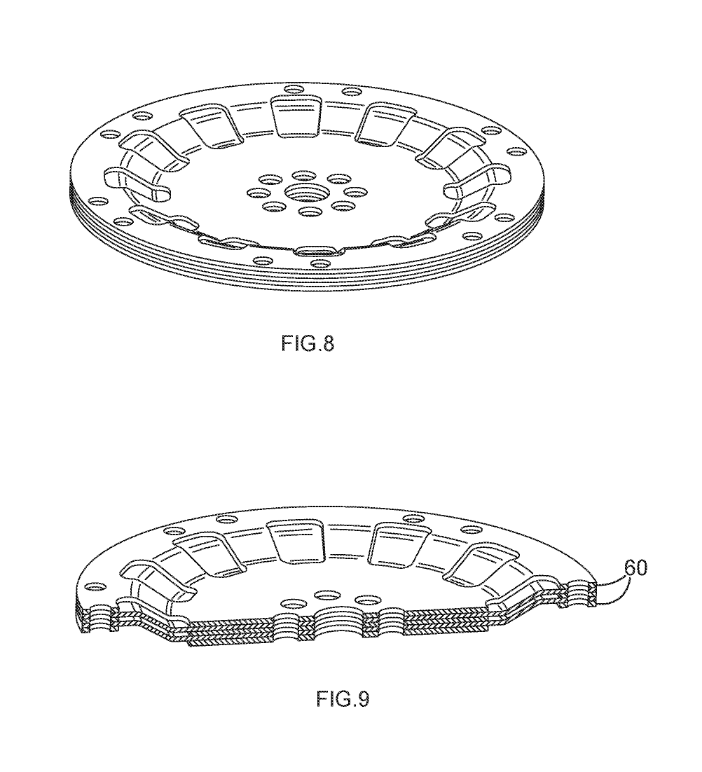

FIG. 8 shows a perspective view of a coupling formed by stacking five dish-shaped discs, each disc with twelve holes which provide six flywheel fixing bolt holes;

FIG. 9 shows a cut-away through the coupling of FIG. 8;

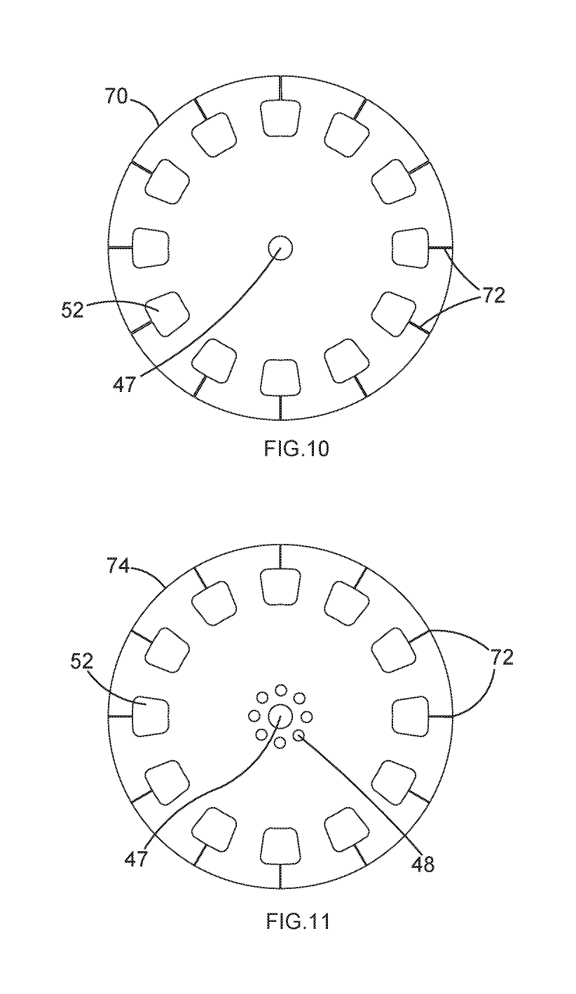

FIG. 10 shows one embodiment of a coupling disc blank;

FIG. 11 shows another embodiment of a coupling disc blank;

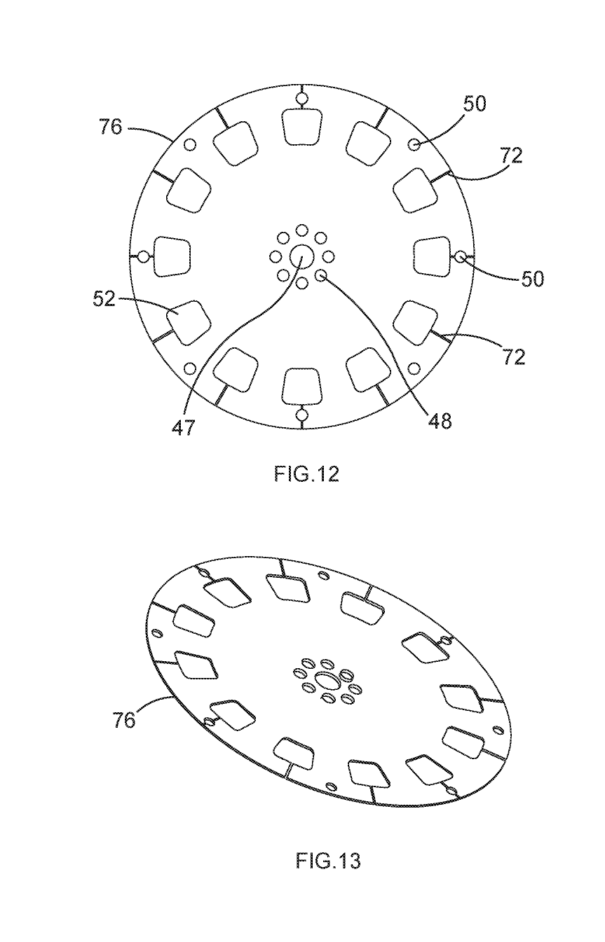

FIG. 12 shows a further embodiment of a coupling disc blank; and

FIG. 13 shows a perspective view of the disc blank of FIG. 12.

FIG. 1 shows parts of a previously considered rotor assembly for a rotating electrical machine. Referring to FIG. 1, the rotor assembly comprises a main rotor 10 and an exciter rotor 12, both of which are mounted on a shaft 14. The main rotor 10 comprises a plurality of salient poles, each of which is wound with rotor windings 16. The exciter rotor comprises exciter windings 18 which are connected to the rotor windings 16 via rotating diodes 20. The main rotor 10 is designed to fit within a main stator (not shown), and the exciter rotor is designed to fit within an exciter stator (not shown). A shaft-mounted fan 22 is also provided.

In the arrangement of FIG. 1, the rotor assembly is connectable to a prime mover by means of a coupling disc (or discs) 24. One side of the coupling disc is connected to the shaft, and the other side of the coupling disc is connected to the prime mover. For example, in the case of an internal combustion engine, the coupling disc 24 may connect to the engine flywheel. The disc 24 has an outer pitch circle of holes, which can be used to bolt the disc to the engine flywheel. In order to connect the disc 24 to the rotor shaft 14, a hub 26 is shrunk on to the shaft. The hub 26 is designed to locate the disc 24 axially and to carry a plurality of bolts 28 that hold the disc in place through an inner pitch circle of holes.

Non-rotating parts of the electrical machine and the prime mover are connectable by means of an adaptor (not shown). The adaptor is typically connected between the generator frame and the flywheel housing, and surrounds the fan 22.

In operation, the rotor assembly is caused to rotate by the prime mover via the coupling disc 24. The disc 24 is the rotary load path for power transfer into the electrical machine through a diaphragm connection. Excitation for the main rotor windings 16 is provided by the exciter rotor 12 via rotating diodes 20. A rotating magnetic flux produced by the main rotor 10 intersects with windings in the main stator (not shown) to produce the electrical output. Cooling air is drawn through the machine by fan 22.

The arrangement shown in FIG. 1 is a single bearing rotor assembly in which a bearing 30 is provided at the non-drive end. The drive end of the rotor assembly is supported by bearings within the prime mover. However a two-bearing rotor assembly, with bearings at each end, could also be used.

It has been found that, when manufacturing a rotor assembly such as that shown in FIG. 1, it may be difficult and expensive to shrink the hub 26 onto the rotor shaft 14. Attempts have therefore been made to reduce machine cost by dispensing with the hub. This may be achieved by drilling and tapping holes axially into the end of the shaft, and bolting the coupling disc directly onto the shaft via a spacer. However, if the coupling disc is bolted directly to the shaft, higher grade bolts may be necessary to achieve the required torque transfer.

The geometry changes associated with higher grade bolts may require more axial space, and failure to accommodate these changes may cause the bolts to interfere with the engine flywheel or flywheel fixing bolts. To solve this problem, it has been proposed to reduce the shaft in length, and to form the disc into a dish shape to extend its axial reach so that the flywheel interface position will not change.

In practice, a coupling may need to be formed from multiple discs in order to meet the power transfer requirements or the structural performance needs. If the discs used are flat, they can be easily stacked. However if the discs are dish-shaped, the bent areas will not be flush, as the surface profiles interfere with one another. This may restrict the use of dish-shaped designs to single disc use, which may limit the torque transmission capabilities.

FIG. 2 shows a coupling disc 40 in accordance with an embodiment of the invention. In this embodiment the disc is for coupling a rotor shaft to an engine fly wheel. Referring to FIG. 2, the coupling disc 40 comprises an inner region 42, an intermediate region 44 and an outer region 46. The intermediate region 44 is radially outwards of and coaxial with the inner region 42. The outer region 46 is radially outwards of and coaxial with the intermediate region 44.

The coupling disc 40 of FIG. 2 is formed into a dish shape, such that the inner region 42 is in a different plane to the outer region 46. The intermediate region 44 is at an angle to the inner region 42 and outer region 46, and connects the two. The inner region 44 and the outer region 46 are both flat, and lie in planes which are parallel to each other and perpendicular to the axis of rotation of the machine. In this embodiment the inner region 42 is substantially circular in shape, the intermediate region 44 is substantial frusto-conical in shape, and the outer region 46 is substantially annular in shape.

In the disc of FIG. 2, the inner region 42 forms a centre plate for engagement with the rotor shaft. A hole 47 in the centre of the disc is used to locate the disc on the shaft. A plurality of bolt holes 48 are provided in the inner region for bolting the inner region 42 to the rotor shaft (optionally via a spacer). In this example eight bolt holes 48 are provided in an inner pitch circle. The bolt holes are evenly spaced about the inner pitch circle. Thus in this example the angle between two adjacent bolt holes 48 is 45°, measured with respect to the centre of the disc.

The outer region 46 forms a rim for engagement with the engine flywheel. A plurality of bolt holes 50 are provided for bolting the outer region to the engine flywheel. In this example eight bolt holes are provided in an outer pitch circle. The outer bolt holes 50 are provided at the same points of the compass as the inner bolt holes 48. Thus an inner bolt hole 48 and a corresponding outer bolt hole 50 both lie on a line from the centre of the disc to its perimeter. In this example the angle between two adjacent bolt holes 50 is 45°.

The intermediate region 44 functions to connect the inner region 42 and the outer region 46 and to hold them in their respective planes.

Still referring to FIG. 2, it can be seen that a plurality of slots 52 are provided in the intermediate region 44. In the embodiment shown, 12 slots are evenly spaced about the intermediate region in a circumferential direction. The slots 52 account for slightly more than 50% of the circumferential area. As a consequence, the intermediate region 44 comprises in essence a series of circumferentially spaced ribs 54, each of which has a width in a circumferential direction which is slightly less than the width of a slot 52.

FIG. 3 illustrates the formation of a stacked coupling using two of the discs shown in FIG. 2. Referring to FIG. 3, two coupling discs A, B are first rotated relative to each other through an angle of 45° (or an odd multiple thereof), which is equivalent to the angular separation of two adjacent bolt holes 48, 50, and 1.5 times the angular separation of two adjacent slots 52. The two discs are then stacked together coaxially to form a stacked coupling C.

The slots 52 are arranged such that, in the stacked coupling, a rib 54 in one disc overlays a slot 52 in the other disc. As a consequence, the surface profiles of the discs do not interfere with one another, and the discs are able to nest together. Furthermore, since the angle of rotation is equivalent to the angle between the bolt holes 48, 50, the bolt holes in the two discs align, allowing bolts to pass through the complete coupling.

Thus, by providing the slots 52 in the intermediate region 44, a plurality of dish-shaped discs can be stacked together without interference between adjacent discs. This can allow the disc (or discs) to meet power transfer requirements and structural performance needs.

FIG. 4 shows a perspective view of a coupling formed by stacking five coupling discs 40 of the type shown in FIG. 2. Referring to FIG. 4, each of the discs is dish-shaped, each with eight flywheel fixing bolt holes. FIG. 5 shows a cut-away through the coupling of FIG. 4.

The stacked dish-shaped coupling described above can be bolted directly to the rotor shaft, thereby negating the need for a hub, and simplifying the shaft machining (no hub interface and a shorter shaft). This is made possible by drilling and tapping bolt holes axially into the end of the shaft. The bolt holes in the shaft accept bolts which pass through the bolt holes 48 in the coupling.

If desired, a spacer may be provided between the coupling disc and the end of the shaft. The spacer has a larger diameter than the shaft, and thus increases the disc shear area and also allows high tensile bolts to stretch to retain the load.

FIG. 6 shows a coupling disc 60 in accordance with another embodiment of the invention. The coupling disc of FIG. 6 is designed for use with six flywheel fixing bolts. In this embodiment, two sets of bolt holes 62, 64 are provided in the outer region 46. Each set of bolt holes consists of six holes spaced evenly around the outer region 46. The two sets of bolt holes 62, 64 are offset from each other by an angle of 15°, which is equivalent to half of the angular separation of the slots 52. As in the first embodiment, eight inner bolt holes 48 are provided in an inner pitch circle.

FIG. 7 illustrates the formation of a stacked coupling disc using two of the discs 60 shown in FIG. 6. Referring to FIG. 7, two coupling discs A, B are first rotated relative to each other. In this case the angle of rotation is 45° or an odd multiple thereof. The rotated discs are then stacked together to form a stacked disc coupling C. The slots 52 are arranged such that a rib in one disc overlays a slot in the other disc. As a consequence, the surface profiles of the discs do not interfere with one another, and the discs are able to nest together.

Since the angle of rotation results in a differential rotation equivalent to an odd multiple of the angle between two sets of bolt holes 62, 64, one set of bolt holes 62 in one disc is aligned with the other set of bolt holes 64 in the adjacent disc. In this way, bolt holes are provided which pass through the compete coupling.

FIG. 8 shows a perspective view of a coupling formed by stacking five coupling discs 60 of the type shown in FIG. 6. Referring to FIG. 8, each of the discs is dish-shaped, each with twelve holes which provide six flywheel fixing bolt holes. FIG. 9 shows a cut-away through the coupling of FIG. 8.

In practice any desired number of dish-shaped discs may be stacked together to meet the power transfer requirements or the structural performance needs. Any number of slots 52 may be provided in the intermediate region, with any appropriate angle between them, as long as a slot in one disc is arranged to align with a rib in another. If desired, two or more different disc geometries could be used. Furthermore, any desired number of bolt holes may be provided in the inner region and the outer region.

Each of the discs described above may be formed from a sheet of metal, such as steel, which is first cut and/or stamped into its initial shape while it is still flat. The disc may then be formed into a dish shape. A further advantage of the slots 52 is that bending of the disc into a dish shape is facilitated by reducing the strain placed on the material.

FIG. 10 shows one embodiment of a coupling disc blank 70 which may be formed into a dish shape. The disc blank is cut and/or stamped from a flat sheet of metal. A plurality of slots 52 are provided in the intermediate region of the disc blank. A centre hole 47 is also provided. However, in this embodiment, no bolt holes are provided in the disc blank.

Still referring to FIG. 10, in this embodiment a plurality of slits 72 are cut into the disc blank. In this example, a parallel slit is cut into the disc radially outwards of each slot 52. Each slit extends radially from the slot 52 to the perimeter of the disc blank.

The slits 72 shown in FIG. 10 are designed such that, as the disc blank is formed into a dish shape, the slits close up. The slits may then be connected, for example by laser welding, to ensure the integrity of the disc. The disc slits allow the ribs to be bent without longitudinal strain.

Once the disc has been formed into a dish shape, bolt holes are drilled into the disc for connecting the disc to the electrical machine and the prime mover. This can help to maintain the accuracy of the final hole positions.

FIG. 11 shows another embodiment of a coupling disc blank. Referring to FIG. 11, the disc blank 74 in this embodiment includes a plurality of bolt holes 48 for connecting the disc to the rotor shaft. Since the location of these bolt holes does not change when the disc is formed into a dish shape, it may be convenient to include these bolt holes in the disc blank. Otherwise the disc blank 74 is the same as the embodiment shown in FIG. 10.

FIG. 12 shows a further embodiment of a coupling disc blank. The disc blank 76 in this embodiment includes a plurality of bolt holes 50 for connecting the disc to the engine flywheel. Otherwise the disc blank 76 is the same as the embodiment shown in FIG. 11. FIG. 13 shows a perspective view of the disc blank 76 of FIG. 12.

Although some of the bolt holes 50 are co-located with slits 72, these are areas of relatively low stress. Furthermore, once the disc is formed into a dish shape, the slits meet and are welded together, for example using laser welding, which provides a sound joint.

The arrangements described above can reduce the cost and complexity of the machine by negating the need for a hub, and simplifying the shaft machining (no hub interface, a shorter shaft and a smaller billet diameter). This may help to improve manufacturability, serviceability and application assembly. Stacking of multiple dished discs can be achieved by rotating the same dish-shaped disc. The slot and rib design feature allows interpenetration of the dishing geometry without the consequence of physical interference of the material. The stackable dished disc concept may facilitate a smaller pitch circle diameter for the coupling disc to the rotor shaft fixing whilst avoiding interference of the fixing screw heads with the flywheel or flywheel fixing bolts.

In a preferred embodiment, the disc is dished at an angle of between 125° and 150° degrees from the vertical to a depth of between 10 mm and 20 mm, and has a uniform thickness of 2.5 mm throughout. It has 12 slots in the intermediate region, each with a width of 15.5 degrees as measured by angles subtended from the centre of the disc. The ribs that are formed each has a width of 14.5 degrees. The slots have a corner radius of 7 mm. According to SAE (Society of Automotive Engineers) standards, SAE 7.5, 10, 11.5, 14, 16, 21 and 24 have eight coupling-to-flywheel fixing holes and SAE 6.5, 8 and 18 have six coupling-to-flywheel fixing holes. For the SAE 6.5, 8 and 18, another set of holes offset by an angle of 15 degrees are made in the annular (outer) region. Both types of disc also have a central hole for locating the disc concentrically to the rotor shaft. A set of eight equally spaced holes are located around this hole for clamping the discs to the shaft.

It will be appreciated that embodiments of the present invention have been described by way of example only, and modifications in detail will be apparent to the skilled person. For example, any appropriate number of slots may be provided in the intermediate region, of any appropriate size and spacing. Furthermore, any appropriate number of bolt holes may be provided in the inner region and the outer region. Although embodiments of the invention have been described with reference to a generating set with an internal combustion engine, the coupling disc may be used with any type of system where it is desired to connect a prime mover to a rotating electrical machine, such as a wind turbine.

1-32. (canceled)

33. A disc arranged to couple a rotating electrical machine to a prime mover, the disc comprising:
an inner region arranged to connect to a rotating component of the electrical machine;
an outer region arranged to connect to a rotating component of the prime mover; and
an intermediate region between the inner region and the outer region;
wherein the inner region and the outer region lie in a different plane, and
the intermediate region comprises a plurality of slots.

34. A disc according to claim 33, wherein the intermediate region is at an angle to the plane of at least one of the inner region and the outer region.

35. A disc according to claim 33, wherein the slots are spaced circumferentially about the intermediate region.

36. A disc according to claim 33, wherein the slots account for at least 50% of the circumferential area around the intermediate region.

37. A disc according to claim 33, wherein the width of the slots in a circumferential direction is equal to or greater than the distance between adjacent slots.

38. A disc according to claim 33, wherein the slots are arranged such that, when two discs are stacked together with one disc rotated with respect to the other, the slots in one disc can align with areas between the slots in the other disc.

39. A disc according to claim 33, wherein the inner region forms a centre plate for engagement with a rotor shaft.

40. A disc according to claim 33, wherein the inner region comprises a plurality of bolt holes for bolting the disc to a rotor shaft.

41. A disc according to claim 33, wherein the outer region forms a rim for engagement with an engine flywheel.

42. A disc according to claim 33, wherein the outer region comprises a plurality of bolt holes for bolting the disc to a rotating component of the prime mover.

43. A disc according to claim 42, wherein some of the bolt holes lie radially outwards of a slot in the intermediate region, and some of the bolt holes lie radially outwards of an area between two adjacent slots in the intermediate region.

44. A disc according to claim 42, wherein the bolt holes are arranged such that, when two discs are rotated and stacked together in such a way that the slots in the intermediate region in one disc align with areas between the slots in the other disc, at least some of the bolt holes in one disc align with at least some of the bolt holes in the other disc.

45. A disc according to claim 42, wherein two sets of bolt holes are provided in the outer region, each set of bolt holes offset from the other by an angle equivalent to half of the angle between two adjacent slots in the intermediate region, or an odd multiple thereof.

46. A disc according to claim 33, the disc comprising a plurality of slits in the outer region.

47. A disc according to claim 46, wherein the slits are located radially outwards of at least some of the slots in the intermediate region.

48. A disc according to claim 46, wherein the slits are arranged such that they close up when the disc is bent into shape.

49. A coupling arranged to couple a rotating electrical machine to a prime mover, the coupling comprising a plurality of discs, each disc comprising:
an inner region arranged to connect to a rotating component of the electrical machine; and
an outer region arranged to connect to a rotating component of the prime mover;
an intermediate region between the inner region and the outer region,
wherein the inner region and the outer region lie in a different plane, and
the intermediate region comprises a plurality of slots.

50. A coupling according to claim 49, wherein the discs are stacked together to form a stack of discs, with alternate discs rotated with respect to the other discs in the stack.

51. A coupling according to claim 49, wherein the discs are arranged such that a slot in one disc is aligned with an area between two slots in an adjacent disc.

52. A method of manufacturing a coupling for coupling a rotating electrical machine to a prime mover, the coupling comprising a plurality of discs, each disc comprising:
an inner region arranged to connect to a rotating component of the electrical machine;
an outer region arranged to connect to a rotating component of the prime mover; and
an intermediate region between the inner region and the outer region,
wherein the disc is manufactured such that the inner region and the outer region lie in a different plane, and the intermediate region comprises a plurality of slots,
the method further comprising stacking the discs together to form a stack of discs, with alternate discs rotated with respect to the other discs in the stack.
